(19) United States
(12) Patent Application Publication
(10) Pub. No.: US 2008/0130279 A1
(43) Pub. Date: Jun. 5, 2008

(54) OPTICAL PLATE HAVING THREE LAYERS AND BACKLIGHT MODULE WITH SAME

(75) Inventors: TUNG-MING HSU, Tu-Cheng (TW); SHAO-HAN CHANG, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/623,303

(22) Filed: Jan. 15, 2007

(30) Foreign Application Priority Data
Dec. 1, 2006 (CN) 200610201194.7

(51) Int. Cl. F21V 5/00

(52) U.S. Cl. 362/246; 362/331; 362/330

(57) ABSTRACT

An exemplary optical plate includes a first transparent layer, a second transparent layer and a light diffusion layer. The light diffusion layer is between the first and second transparent layers. The light diffusion layer, the first and second transparent layers are integrally formed. The light diffusion layer includes a transparent matrix resin and a plurality of diffusion particles dispersed in the transparent matrix resin. The first transparent layer includes a plurality of first V-shaped protrusions at an outer surface distalmost from the second transparent layer. The second transparent layer includes a plurality of second V-shaped protrusions at an outer surface distalmost from the first transparent layer. A direct type backlight module using the optical plate is also provided.

### BACKGROUND OF THE INVENTION

1. Field of the Invention

The present invention relates to an optical plate for use in, for example, a backlight module, the backlight module typically being employed in a liquid crystal display (LCD).

2. Discussion of the Related Art

The lightness and slimness of LCD panels make them suitable for use in a wide variety of electronic devices such as personal digital assistants (PDAs), mobile phones, portable personal computers, and other electronic appliances. Liquid crystal is a substance that does not itself emit light. Instead, the liquid crystal relies on receiving light from a light source in order to display images and data. In the case of a typical LCD panel, a backlight module powered by electricity supplies the needed light.

FIG. 6 is an exploded, side cross-sectional view of a typical direct type backlight module 10 employing a typical optical diffusion plate. The backlight module 10 includes a housing 11, a plurality of lamps 12 disposed on a base of the housing 11 for emitting light rays, and a light diffusion plate 13 and a prism sheet 15 stacked on a top of the housing 11 in that order. The housing 11 is configured for reflecting certain of the light rays upwards. The light diffusion plate 13 includes a plurality of dispersion particles. The dispersion particles are configured for scattering the light rays, and thereby enhancing the uniformity of light output from the light diffusion plate 13. This can correct what might otherwise be a narrow viewing angle experienced by a user of a corresponding LCD panel. The prism sheet 15 includes a plurality of V-shaped structures at a top thereof.

In use, light rays from the lamps 12 enter the prism sheet 15 after being scattered in the light diffusion plate 13. The light rays are refracted in the prism sheet 15 and concentrated by the V-shaped structures so as to increase brightness of light illumination, and finally propagate into an LCD panel (not shown) disposed above the prism sheet 15. The brightness may be improved by the V-shaped structures, but the viewing angle may be narrowed. In addition, even though the light diffusion plate 13 and the prism sheet 15 abut each other, a plurality of air pockets still exists at the boundary between them. When the backlight module 10 is in use, light passes through the air pockets, and some of the light undergoes total reflection at one or another of the interfaces at the air pockets. As a result, the light energy utilization ratio of the backlight module 10 is reduced.

Therefore, a new optical means is desired in order to overcome the above-described shortcomings.

### SUMMARY

An optical plate includes a first transparent layer, a second transparent layer and a light diffusion layer. The light diffusion layer is laminated between the first and second transparent layers. The light diffusion layer, the first and second transparent layers are integrally formed. The light diffusion layer includes a transparent matrix resin and a plurality of diffusion particles dispersed in the transparent matrix resin. The first transparent layer includes a plurality of first V-shaped protrusions at an outer surface thereof that is distalmost from the second transparent layer. The second transparent layer includes a plurality of second V-shaped protrusions at an outer surface thereof that is distalmost from the first transparent layer.

Other novel features and advantages will become more apparent from the following detailed description, when taken in conjunction with the accompanying drawings.

### BRIEF DESCRIPTION OF THE DRAWINGS

The components in the drawings are not necessarily drawn to scale, the emphasis instead being placed upon clearly illustrating the principles of the present optical plate and backlight module. Moreover, in the drawings, like reference numerals designate corresponding parts throughout the several views, and all the views are schematic.

FIG. 1 is an isometric view of an optical plate in accordance with a first embodiment of the present invention.

FIG. 2 is a side cross-sectional view of the optical plate of FIG. 1, taken along line II-II thereof.

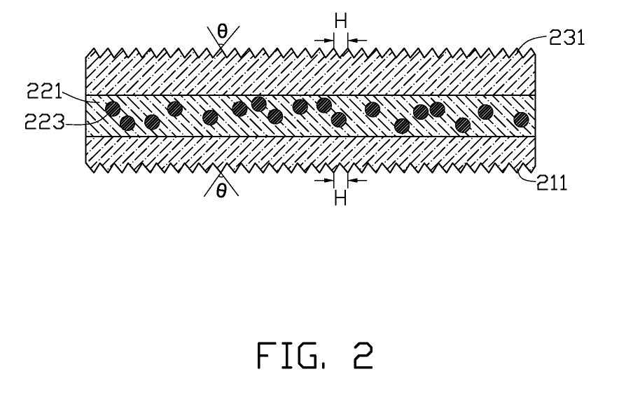

FIG. 3 is a side cross-sectional view of the optical plate of FIG. 1, taken along line III-III thereof.

FIG. 4 is a side cross-sectional view of a direct type backlight module in accordance with a second embodiment of the present invention, the backlight module including the optical plate shown in FIG. 1.

FIG. 5 is a side cross-sectional view of an optical plate in accordance with a third embodiment of the present invention.

FIG. 6 is an exploded, side cross-sectional view of a conventional backlight module.

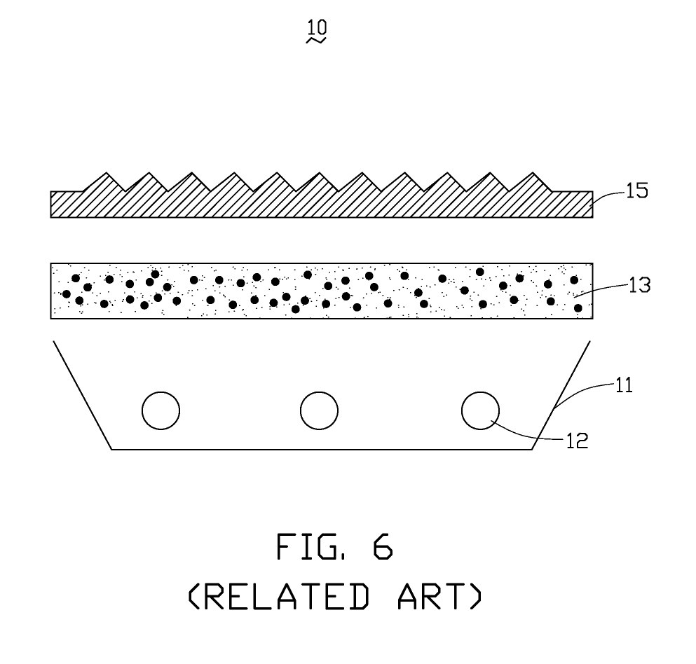

### DETAILED DESCRIPTION OF THE EMBODIMENTS

Reference will now be made to the drawings to describe preferred embodiments of the present optical plate and backlight module, in detail.

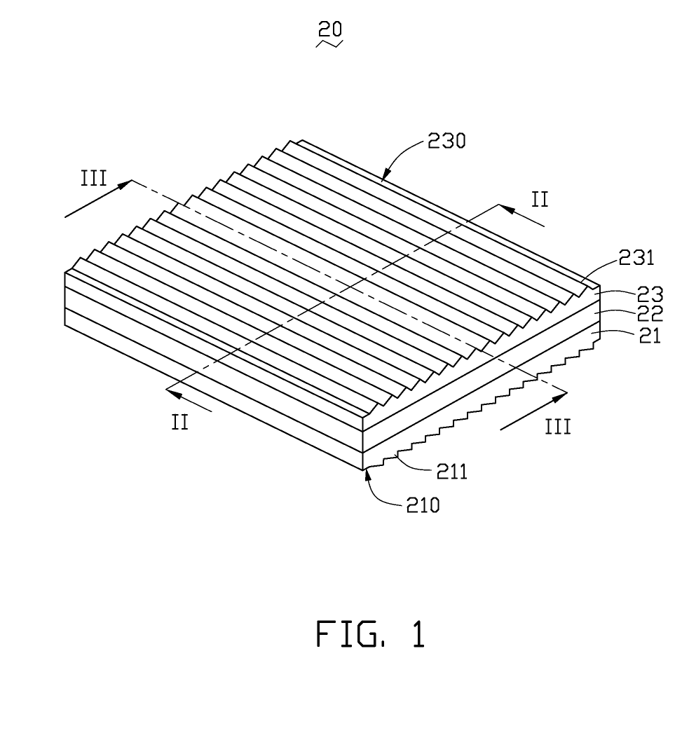

Referring to FIG. 1, an optical plate 20 according to a first embodiment of the present invention is shown. The optical plate 20 includes a first transparent layer 21, a light diffusion layer 22, and a second transparent layer 23. The first transparent layer 21, the light diffusion layer 22, and the second transparent layer 23 are integrally formed, with the light diffusion layer 22 being between the first and second transparent layers 21, 23. The first transparent layer 21 and the light diffusion layer 22 are in immediate contact with each other at a common interface thereof. Similarly, the second transparent layer 23 and the light diffusion layer 22 are in immediate contact with each other at a common interface thereof. This kind of unified body with no gaps in the common interfaces can be made by multi-shot injection molding technology. The first transparent layer 21 defines a plurality of first V-shaped protrusions 211 at an outer surface 210 thereof that is distalmost from the second transparent layer 23. The second transparent layer 23 defines a plurality of second V-shaped protrusions 231 at an outer surface 230 thereof that is distalmost from the first transparent layer 21.

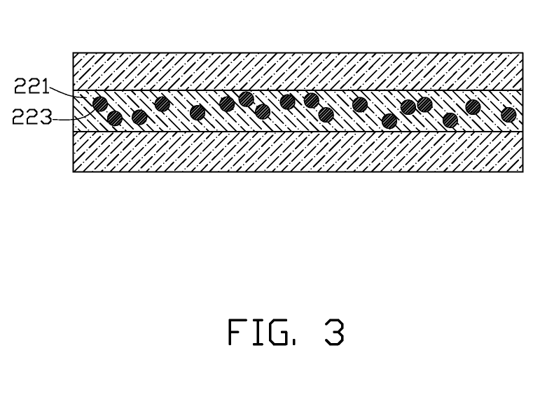

Further referring to FIG. 3, each of the first V-shaped protrusions 211 is an elongated prism (or ridge) that extends along a direction parallel to a side surface of the optical plate 20. The first V-shaped protrusions 211 are aligned side by side on the outer surface 210 of the first transparent layer 21, and are parallel to each other. A pitch H between two adjacent first V-shaped protrusions 211 is in the range from about 0.025 millimeters to about 1 millimeter. A vertex angle θ of each of the first V-shaped protrusions 211 is in the range from about 60 degrees to about 120 degrees. In the illustrated embodiment, the second V-shaped protrusions 231 are configured to be similar to the first V-shaped protrusions 211. In alternative embodiments, the second V-shaped protrusions 231 can be different from the first V-shaped protrusions 211. Also, in alternative embodiments, each of the first V-shaped protrusions 211 and/or each of the second V-shaped protrusions 231 can be oriented at an angle relative to the side surface of the optical plate 20. Further, each of the first V-shaped protrusions 211 can be oriented at an angle relative to each of the second V-shaped protrusions 311.

A thickness of each of the first transparent layer 21, the light diffusion layer 22, and the second transparent layer 23 may be greater than or equal to 0.35 millimeters. In a preferred embodiment, a combined thickness of the first transparent layer 21, the light diffusion layer 22, and the second transparent layer 23 is in the range from about 1.05 millimeters to about 6 millimeters. Each of the first transparent layer 21 and the second transparent layer 23 can be made of transparent matrix resin selected from the group consisting of polyacrylic acid (PAA), polycarbonate (PC), polystyrene (PS), polymethyl methacrylate (PMMA), methylmethacrylate and styrene copolymer (MS), and any suitable combination thereof. It should be pointed out that the materials of the first and second transparent layers 21, 23 can be either the same or different.

The light diffusion layer 22 includes a transparent matrix resin 221, and a plurality of diffusion particles 223 uniformly dispersed in the transparent matrix resin 221. The light diffusion layer 22 is configured for enhancing optical uniformity. The transparent matrix resin 221 is made of transparent matrix resin selected from the group including polyacrylic acid (PAA), polycarbonate (PC), polystyrene (PS), polymethyl methacrylate (PMMA), methylmethacrylate and styrene copolymer (MS), and any suitable combination thereof. The diffusion particles 223 can be made of material selected from the group consisting of titanium dioxide, silicon dioxide, acrylic resin, and any combination thereof. The diffusion particles 223 are configured for scattering light rays and enhancing the light distribution of the light diffusion layer 22. The light diffusion layer 22 preferably has a light transmission ratio in the range from 30% to 98%. The light transmission ratio of the light diffusion layer 22 is determined by a composition of the transparent matrix resin 221 and the diffusion particles 223.

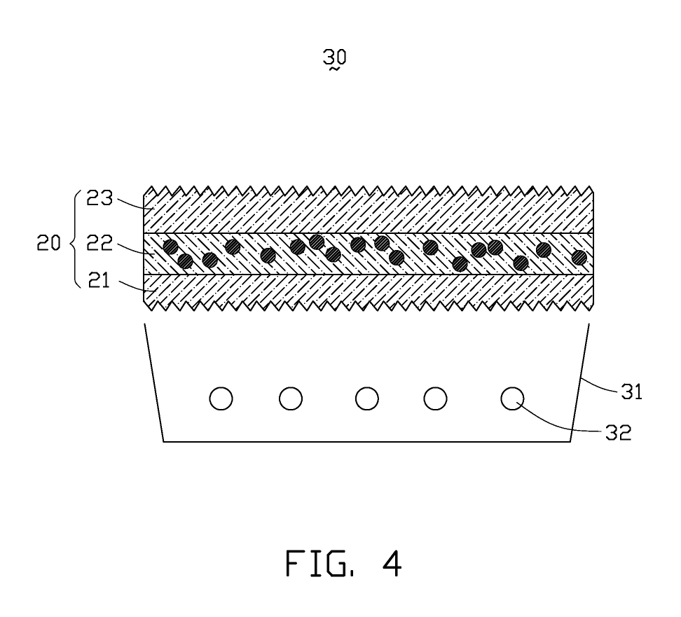

Referring to FIG. 4, a direct type backlight module 30 according to a second embodiment of the present invention is shown. The backlight module 30 includes a housing 31, a plurality of lamp tubes 32, and the optical plate 20. The lamp tubes 32 are regularly arranged above a base of the housing 31. The optical plate 20 is positioned on top of the housing 31, with the first transparent layer 21 facing the lamp tubes 32. It should be pointed out that in an alternative embodiment, the second transparent layer 23 of the optical plate 20 can be arranged to face the lamp tubes 32. That is, light rays from the lamp tubes 32 can enter the optical plate 20 via a selected one of the first transparent layer 21 or the second transparent layer 23.

In the backlight module 30, when the light rays enter the optical plate 20 via the first transparent layer 21, the light rays are diffused by the first V-shaped protrusions 211 of the first transparent layer 21. Then the light rays are further substantially diffused in the light diffusion layer 22 of the optical plate 20. Finally, many or most of the light rays are condensed by the second V-shaped protrusions 231 of the second transparent layer 23 before they exit the optical plate 20. Therefore, a brightness of the backlight module 30 is increased. In addition, the light rays are diffused at two levels, so that an optical uniformity of the optical plate 20 is enhanced. Furthermore, the first transparent layer 21, the light diffusion layer 22, and the second transparent layer 23 are integrally formed together (see above), with no air or gas pockets trapped in the respective interfaces therebetween. Thus the efficiency of utilization of light rays is increased. Moreover, when the optical plate 20 is utilized in the backlight module 30, the optical plate 20 in effect replaces the conventional combination of a diffusion plate and a prism sheet. Thereby, a process of assembly of the backlight module 30 is simplified, and the efficiency of assembly is improved. Still further, in general, a volume occupied by the optical plate 20 is less than that occupied by the conventional combination of a diffusion plate and a prism sheet. Thereby, a volume of the backlight module 30 is reduced.

In the alternative embodiment, when the light rays enter the optical plate 20 via the second transparent layer 23, the optical uniformity of the optical plate 20 is also enhanced, and the utilization efficiency of light rays is also increased. Nevertheless, the light rays emitted from the optical plate 20 via the first transparent layer 21 are different from the light rays emitted from the optical plate 20 via the second transparent layer 23. For example, when the light rays enter the optical plate 20 via the first transparent layer 21, a viewing angle of the backlight module 30 is somewhat larger than that of the backlight module 30 when the light rays enter the optical plate 20 via the second transparent layer 23.

In the optical plate 20, an interface between the light diffusion layer 22 and the first transparent layer 21 is flat. Similarly, an interface between the light diffusion layer 22 and the second transparent layer 23 is flat. In one kind of alternative embodiment, the interface between the light diffusion layer 22 and the first transparent layer 21 may be non-planar. One example if this kind of configuration is given below.

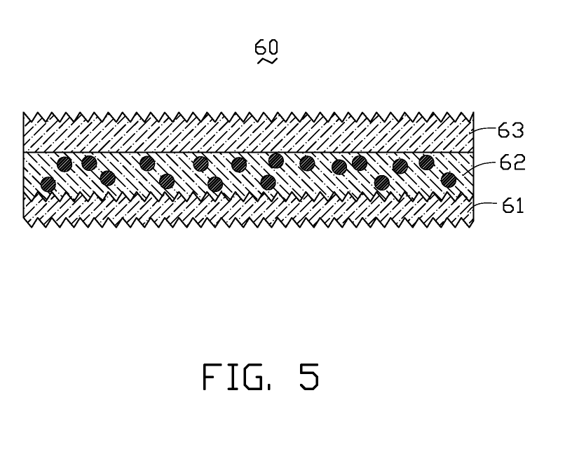

Referring to FIG. 5, an optical plate 60 according to a third embodiment of the present invention is shown. The optical plate 60 includes a first transparent layer 61, a light diffusion layer 62, and a second transparent layer 63. The optical plate 60 is similar in principle to the optical plate 20 of the first embodiment, except that an interface (not labeled) between the first transparent layer 61 and the light diffusion layer 62 is a wavy interface. Therefore, a binding strength between the first transparent layer 61 and the light diffusion layer 62 can be increased.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. An optical plate, comprising:
a first transparent layer;
a second transparent layer; and
a light diffusion layer between the first transparent layer and the second transparent layer, the light diffusion layer including a transparent matrix resin and a plurality of diffusion particles dispersed in the transparent matrix resin, wherein the first transparent layer, the light diffusion layer, and the second transparent layer are integrally formed, with the first transparent layer in immediate contact with the light diffusion layer, and the second transparent layer in immediate contact with the light diffusion layer, and the first transparent layer comprises a plurality of first V-shaped protrusions at an outer surface thereof distalmost from the second transparent layer, and the second transparent layer comprises a plurality of second V-shaped protrusions at an outer surface thereof distalmost from the first transparent layer.

2. The optical plate as claimed in claim 1, wherein a thickness of each of the light diffusion layer, the first transparent layer, and the second transparent layer is greater than or equal to 0.35 millimeters.

3. The optical plate as claimed in claim 2, wherein a combined thickness of the light diffusion layer, the first transparent layer and second transparent layer is in the range from about 1.05 millimeters to about 6 millimeters.

4. The optical plate as claimed in claim 1, wherein each of the first transparent layer and the second transparent layer is made of material selected from the group consisting of polyacrylic acid, polycarbonate, polystyrene, polymethyl methacrylate, methylmethacrylate and styrene copolymer, and any combination thereof.

5. The optical plate as claimed in claim 1, wherein each of the first V-shaped protrusions and the second V-shaped protrusions is an elongated prism that extends along a direction parallel to one side surface of the optical plate.

6. The optical plate as claimed in claim 1, wherein a pitch between adjacent first V-shaped protrusions is in the range from about 0.025 millimeters to about 1.5 millimeters, and a pitch between adjacent second V-shaped protrusions is in the range from about 0.025 millimeters to about 1.5 millimeters.

7. The optical plate as claimed in claim 1, wherein a vertex angle of each first V-shaped protrusion is in the range from about 60 degrees to about 120 degrees, and a vertex angle of each second V-shaped protrusion is in the range from about 60 degrees to about 120 degrees.

8. The optical plate as claimed in claim 1, wherein at least one of the following pluralities of V-shaped protrusions is slanted toward a side surface of the optical plate: the first V-shaped protrusions, and the second V-shaped protrusions.

9. The optical plate as claimed in claim 8, wherein each of the first V-shaped protrusions is oriented at an angle relative to each of the second V-shaped protrusions.

10. The optical plate as claimed in claim 1, wherein at least one of the following interfaces is flat: an interface between the light diffusion layer and the first transparent layer, and an interface between the light diffusion layer and the second transparent layer.

11. The optical plate as claimed in claim 1, wherein at least one of the following interfaces is curved: an interface between the light diffusion layer and the first transparent layer, and an interface between the light diffusion layer and the second transparent layer.

12. The optical plate as claimed in claim 1, wherein the transparent matrix resin of the transparent layer is made of material selected from the group consisting of polyacrylic acid, polycarbonate, polystyrene, polymethyl methacrylate, methylmethacrylate and styrene, and any combination thereof.

13. The optical plate as claimed in claim 1, wherein a material of the diffusion particles is selected from the group consisting of titanium dioxide, silicon dioxide, acrylic resin, and any combination thereof.

14. A direct type backlight module, comprising:
a housing;
a plurality of light sources disposed on or above a base of the housing; and
an optical plate disposed above the light sources at a top of the housing, the optical plate comprising:
a first transparent layer;
a second transparent layer; and
a light diffusion layer between the first transparent layer and the second transparent layer, the light diffusion layer including a transparent matrix resin and a plurality of diffusion particles dispersed in the transparent matrix resin, wherein the first transparent layer, the light diffusion layer, and the second transparent layer are integrally formed, with the first transparent layer in immediate contact with the light diffusion layer, and the second transparent layer in immediate contact with the light diffusion layer, and the first transparent layer comprises a plurality of first V-shaped protrusions at an outer surface thereof distalmost from the second transparent layer, and the second transparent layer comprises a plurality of second V-shaped protrusions at an outer surface thereof distalmost from the first transparent layer.

15. The direct type backlight module as claimed in claim 14, wherein a selected one of the first transparent layer and the second transparent layer of the optical plate is arranged to face the light sources, wherein light rays from the light sources can enter the optical plate via the corresponding first transparent layer or second transparent layer.
